(19) United States
(12) Patent Application Publication
(10) Pub. No.: US 2017/0009105 A1
(43) Pub. Date: Jan. 12, 2017

(54) METHODS OF PREPARING SURFACE MODIFIED PRESSURE SENSITIVE ADHESIVE ARTICLES

(71) Applicant: 3M INNOVATIVE PROPERTIES COMPANY, Saint Paul, MN (US)

(72) Inventors: John P. Baetzold, North St. Paul, MN (US); Audrey A. Sherman, Woodbury, MN (US); Brian T. Weber, St. Paul, MN (US); John J. Stradinger, Roseville, MN (US); Mikhail L. Pekurovsky, Bloomington, MN (US); Suman K. Patel, Woodbury, MN (US); Frank T. Sher, St. Paul, MN (US)

(21) Appl. No.: 15/115,717

(22) PCT Filed: Jan. 28, 2015
(86) PCT No.: PCT/US2015/013238

§ 371 Date: Aug. 1, 2016

Related U.S. Application Data
(60) Provisional application No. 61/934,896, filed on Feb. 3, 2014.

(51) Int. Cl. C09J 7/02; B32B 38/00; B32B 37/12

(52) U.S. Cl. CPC C09J 7/0207; C09J 7/0232; B32B 37/1284; B32B 38/145; C09J 2201/32; C09J 2483/00; C09J 2433/00; B32B 2405/00

(57) ABSTRACT

Adhesive articles include a substrate with a first major surface and a second major surface, a layer of pressure sensitive adhesive with a first major surface and a second major surface, where the second major surface of the pressure sensitive adhesive layer is disposed on the first major surface of the substrate, and a plurality of non-pressure sensitive adhesive structures disposed on the first major surface of the pressure sensitive adhesive layer. The plurality of non-pressure sensitive adhesive structures are arrayed in a random or non-random pattern, and are applied to the first major surface of the pressure sensitive adhesive layer by direct contact printing. The articles may also include a microstructured release liner or conformable sheet covering the first major surface of the pressure sensitive adhesive layer and the plurality of non-pressure sensitive adhesive structures.

### FIELD OF THE DISCLOSURE

The present disclosure relates generally to pressure sensitive adhesive articles, specifically pressure adhesives that are surface modified, and methods of preparing such articles.

### BACKGROUND

Adhesives have been used for a variety of marking, holding, protecting, sealing and masking purposes. Adhesive tapes generally comprise a backing, or substrate, and an adhesive. One type of adhesive, a pressure sensitive adhesive (PSA), is particularly preferred for many applications.

PSAs are well known to one of ordinary skill in the art to possess certain properties at room temperature including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs are polymers designed and formulated to exhibit the requisite viscoelastic properties resulting in a desired balance of tack, peel adhesion, and shear strength. The most commonly used polymers for preparation of PSAs are natural rubber, synthetic rubbers (e.g., styrene/butadiene copolymers (SBR) and styrene/isoprene/styrene (SIS) block copolymers), and various (meth)acrylate (e.g., acrylate and methacrylate) copolymers. With the exception of several (meth)acrylates, which are inherently tacky, these polymers are typically blended with appropriate tackifying resins to render them pressure sensitive.

A variety of techniques have been used to prepare pressure sensitive adhesives that are positionable or repositionable. Generally speaking, positionable pressure sensitive adhesive articles are those in which the pressure sensitive adhesive surface has sufficiently low tack as to allow the pressure sensitive adhesive to be slid across the surface of a substrate to which it is to be adhered without sticking or grabbing. Similarly, repositionable pressure sensitive adhesive articles are those in which the pressure sensitive adhesive has relatively low initial adhesion (permitting temporary removability from and repositionability on a substrate after application), with a building of adhesion over time to form a sufficiently strong bond.

In U.S. Pat. No. 6,565,697 (Maercklein), a method of making a positionable and repositionable pressure sensitive adhesive is described which includes depositing a layer of liquid adhesive material onto a substrate and depositing a layer of non-pressure sensitive adhesive liquid material onto the liquid adhesive material, wherein the non-pressure sensitive adhesive liquid material covers only a portion of the liquid adhesive layer. The liquid layers can be cured.

In addition, several applications have been described in which microstructured adhesive layers have beads or pegs that protrude from the adhesive surface to make the adhesive surface positionable or repositionable upon contact with a substrate surface. U.S. Pat. No. 5,296,277 (Wilson et al.) describes such a system. U.S. Pat. No. 7,060,351 (Hannington) and U.S. Pat. No. 6,630,049 (Hannington et al.), describe an adhesive article that provides air egress, by providing an area of no initial adhesion for the air to flow out from under the construction. In the article, a continuous layer of adhesive is adhered to a surface that has a plurality of spaced-apart non-pressure sensitive adhesive material, and the non-pressure sensitive adhesive material becomes embedded in the adhesive layer. In U.S. Pat. No. 6,630,049, the spaced-apart non-pressure sensitive adhesive material can be printed onto the pressure sensitive adhesive surface and then embedded into the surface by pressure applied through a release liner, or the spaced-apart non-pressure sensitive adhesive material can be printed and embedded in a single step.

### SUMMARY

Described herein are pressure sensitive adhesive articles which have been surface modified. Also disclosed are methods of preparing such adhesive articles. In some embodiments, the adhesive articles comprise a substrate comprising a first major surface and a second major surface, a layer of pressure sensitive adhesive comprising a first major surface and a second major surface, where the second major surface of the pressure sensitive adhesive layer is disposed on the first major surface of the substrate, and a plurality of non-pressure sensitive adhesive structures disposed on the first major surface of the pressure sensitive adhesive layer. The plurality of non-pressure sensitive adhesive structures are arrayed in a random or non-random pattern, wherein the non-pressure sensitive adhesive structures are applied to the first major surface of the pressure sensitive adhesive layer by direct contact printing. The articles may also include a protective sheet covering the first major surface of the pressure sensitive adhesive layer and the plurality of non-pressure sensitive adhesive structures. This protective sheet may be a microstructured release liner or conformable sheet or a sheet with a conformable surface coating.

Also disclosed are methods for making adhesive laminate articles. These methods include providing a pressure sensitive adhesive layer comprising a first major surface and a second major surface, where at least one of the major surfaces comprises a plurality of non-pressure sensitive adhesive structures disposed on the major surface of the pressure sensitive adhesive layer, and contacting the adhesive layer to the surface of an article to form a laminate. The plurality of non-pressure sensitive adhesive structures are arrayed in a random or non-random pattern, and the non-pressure sensitive adhesive structures are applied to the major surface of the pressure sensitive adhesive layer by direct contact printing.

The method may further include applying pressure to the laminate, such that, prior to applying pressure to the laminate, the adhesive layer is positionable and/or repositionable, and such that the plurality of non-pressure sensitive adhesive structures become at least partially submerged in the adhesive layer.

The method for providing the adhesive layer includes providing a substrate, the substrate having a first major surface and a second major surface, applying an adhesive or pre-adhesive composition to the first major surface of the substrate to form a pressure sensitive adhesive layer with a first major surface and a second major surface, where the second major surface of the pressure sensitive adhesive layer is adjacent to the first major surface of the substrate, and direct contact printing a material onto the first major surface of the pressure sensitive adhesive layer.

### BRIEF DESCRIPTION OF THE DRAWINGS

The present application may be more completely understood in consideration of the following detailed description of various embodiments of the disclosure in connection with the accompanying drawings.

FIGS. 1A-1D show a cross-sectional view of an exemplary embodiment of this disclosure.

FIGS. 2A-2C show confocal microscope profiles of a series of non-pressure sensitive adhesive structures printed onto an adhesive surface.

FIGS. 3A-3C show confocal microscope profiles of a series of non-pressure sensitive adhesive structures printed onto an adhesive surface, where the non-pressure sensitive adhesive structures have been pressed into the adhesive surface.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The use of adhesives, especially pressure sensitive adhesives, in areas such as the medical, electronic, automotive, energy, and optical industries is increasing. The requirements of these industries place additional demands upon the pressure sensitive adhesive beyond the traditional properties of tack, peel adhesion and shear holding power. New classes of materials are desirable to meet the increasingly demanding performance requirements for pressure sensitive adhesives. Among the performance requirements for new classes of pressure sensitive adhesives are positionability and repositionability.

As used herein, the term “positionability” when used to describe a pressure sensitive adhesive means that the pressure sensitive adhesive surface has sufficiently low tack as to allow the pressure sensitive adhesive to be slid across the surface of a substrate to which it is to be adhered without sticking or grabbing.

As used herein, the term “repositionability” is used synonymously with the term “temporary removability”, and when used to describe a pressure sensitive adhesive means that the pressure sensitive adhesive has relatively low initial adhesion (permitting temporary removability form and repositionability on a substrate after application), with a building of adhesion over time to form a sufficiently strong bond.

Despite continuous progress, the need remains for adhesives, especially pressure sensitive adhesives, that have modified properties. It is particularly desirable to be able to modify the adhesive only at the surface and not throughout the bulk of the adhesive layer. Adding a modifying additive throughout the bulk of the adhesive layer can dramatically change the properties of the adhesive layer and, depending upon the modifying additive, preparing such modified adhesives can be expensive and labor-intensive. Modification of the adhesive surface reduces the amount of modifying agent needed as well as minimizing the impact of the modification to the bulk adhesive layer.

In this disclosure, modified adhesive surfaces, methods for modifying adhesive surfaces and articles prepared from modified adhesive surfaces are presented. Disclosed herein are adhesive articles comprising a substrate having a first major surface and a second major surface, a layer of pressure sensitive adhesive comprising a first major surface and a second major surface, where the second major surface of the pressure sensitive adhesive layer is disposed on the first major surface of the substrate, and a plurality of non-pressure sensitive adhesive structures disposed on the first major surface of the pressure sensitive adhesive layer. The plurality of non-pressure sensitive adhesive structures are arrayed in a random or non-random pattern, and the non-pressure sensitive adhesive structures are applied to the first major surface of the pressure sensitive adhesive layer by direct contact printing.

By using direct contact printing to form the plurality of non-pressure sensitive adhesive structures on the surface of the pressure sensitive adhesive layer, non-pressure sensitive adhesive structures that are firmly anchored to the adhesive layer are formed. By firmly anchored it is meant that the non-pressure sensitive adhesive structures are not readily removed from the surface by normal contact with substrates such as release liners and substrates to which the adhesive layer is to be adhered. While not wishing to be bound by theory, it is believed that the contact between a printing tool coated with a material to be deposited on the adhesive layer and the adhesive surface assists in anchorage of the material to the adhesive layer. This is in contrast with non-contact printing methods, such as, for example, ink jet printing, where material is jetted onto the adhesive layer without there being contact. Additionally, the contact printing techniques do not require the co-curing of the adhesive layer and the deposited material layer as is described, for example in U.S. Pat. No. 6,565,697 (Maercklein). The contact printing techniques of this disclosure also contrast with the embedded non-adhesive structures taught by Hannington et al. in U.S. Pat. No. 6,630,049. Whereas Hannington teaches and requires that the non-adhesive structures, which can be printed onto the adhesive surface, be embedded in the adhesive layer (typically 75% or even 85% of the thickness of the non-adhesive material is embedded in the adhesive layer), the non-adhesive structures of the present disclosure are not embedded in the adhesive layer.

Non-adhesive structures are printed onto the adhesive surface and not embedded in the adhesive layer by contact printing techniques that do not involve contact of the printing tool with the adhesive surface, rather a layer of printed fluid remains between the tool and the adhesive surface. While not wishing to be bound by theory, it is believed that this layer of printed fluid helps to prevent the printed structures from becoming embedded in the adhesive layer. Another consequence of this technique is that when the tool is removed from the adhesive surface, some of the fluid remains on the adhesive surface and some remains on the tool surface.

In some embodiments, it may be desirable for the plurality of non-pressure sensitive adhesive structures to remain on the surface of the adhesive layer throughout the useful life of the adhesive article, such as, for example, in the case where the plurality of non-pressure sensitive adhesive structures forms a circuit. In other embodiments, the plurality of non-pressure sensitive adhesive structures becomes immersed in the adhesive layer such that the surface effect of the plurality of non-pressure sensitive adhesive structures is a temporary effect, such as providing positionability or repositionability. In yet other embodiments, the plurality of non-pressure sensitive adhesive structures comprises a combination of non-pressure sensitive adhesive structures, some of which become immersed in the adhesive layer and others which remain of the surface of the adhesive layer throughout the useful life of the adhesive article.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “adhesive” as used herein refers to polymeric compositions useful to adhere together two adherends. Examples of adhesives are heat activated adhesives and pressure sensitive adhesives.

Heat activated adhesives are non-tacky at room temperature but become tacky and capable of bonding to a substrate at elevated temperatures. These adhesives usually have a T_{g} (glass transition temperature) or melting point (Tₘ) above room temperature. When the temperature is elevated above the T_{g} or Tₘ, the storage modulus usually decreases and the adhesive becomes tacky.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

As used herein, the term “release liner”, used interchangeably with the term “liner”, refers to a thin flexible sheet which after being placed in intimate contact with an adhesive surface may be subsequently removed without damaging the adhesive coating.

As used herein, the term “structured liner” refers to a liner with a structured surface, and the term “microstructured liner” refers to a liner with a microstructured surface.

As used herein, the term “backing” refers to a thin, flexible sheet which, after being placed in intimate contact with an adhesive cannot be subsequently removed without damaging the adhesive coating.

As used herein, the term “microscopic” refers to features of small enough dimension so as to require an optic aid to the naked eye when viewed from any plane of view to determine its shape. One criterion is found in Modem Optic Engineering by W. J. Smith, McGraw-Hill, 1966, pages 104-105 whereby visual acuity, “ . . . is defined and measured in terms of the angular size of the smallest character that can be recognized.” Normal visual acuity is considered to be when the smallest recognizable letter subtends an angular height of 5 minutes of arc on the retina. At a typical working distance of 250 mm (10 inches), this yields a lateral dimension of 0.36 mm (0.0145 inch) for this object.

As used herein, the term “microstructure” means the configuration of features wherein at least 2 dimensions of the features are microscopic. The topical and/or cross-sectional view of the features must be microscopic.

The terms “glass transition temperature” and “Tg” are used interchangeably. Typically Tg values are measure using Differential Scanning calorimetry (DSC) unless otherwise noted.

The term “room temperature” refers to ambient temperature, generally 20-22° C., unless otherwise noted.

The term “(meth)acrylate” refers to monomeric acrylic or methacrylic esters of alcohols. Acrylate and methacrylate monomers or oligomers are referred to collectively herein as “(meth)acrylates”. Polymers described as “(meth)acrylate-based” are polymers or copolymers prepared primarily (greater than 50% by weight) from (meth)acrylate monomers and may include additional ethylenically unsaturated monomers.

Unless otherwise indicated, “optically transparent” refers to an article, film or adhesive composition that has a high light transmittance over at least a portion of the visible light spectrum (about 400 to about 700 nm).

Unless otherwise indicated, “optically clear” refers to an adhesive or article that has a high light transmittance over at least a portion of the visible light spectrum (about 400 to about 700 nm), and that exhibits low haze.

The term “wavelength of visible light” as used herein encompasses the wavelengths of the light spectrum that constitutes visible light (about 400 to about 700 nm).

Refractive index is defined herein as the absolute refractive index of a material (e.g., a monomer or the polymerized product thereof) which is understood to be the ratio of the speed of electromagnetic radiation in free space to the speed of the radiation in that material, with the radiation being of sodium yellow light at a wavelength of about 583.9 nanometers (nm). The refractive index can be measured using known methods and is generally measured using an Abbe Refractometer.

The term “adjacent” as used herein when referring to two layers means that the two layers are in proximity with one another with no intervening open space between them. They may be in direct contact with one another (e.g. laminated together) or there may be intervening layers.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, iso-butyl, tert-butyl, n-pentyl, n-hexyl, cyclohexyl, n-heptyl, n-octyl, and ethylhexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

The terms “free radically polymerizable” and “ethylenically unsaturated” are used interchangeably and refer to a reactive group which contains a carbon-carbon double bond which is able to be polymerized via a free radical polymerization mechanism.

As mentioned above, disclosed herein are adhesive articles comprising a substrate having a first major surface and a second major surface, a layer of pressure sensitive adhesive comprising a first major surface and a second major surface, where the second major surface of the pressure sensitive adhesive layer is disposed on the first major surface of the substrate, and a plurality of non-pressure sensitive adhesive structures disposed on the first major surface of the pressure sensitive adhesive layer. The plurality of non-pressure sensitive adhesive structures are arrayed in a random or non-random pattern, and the non-pressure sensitive adhesive structures are applied to the first major surface of the pressure sensitive adhesive layer by direct contact printing.

A wide variety of pressure sensitive adhesives are suitable for forming the pressure sensitive adhesive layer which can be modified to form the surface-modified adhesives of this disclosure. Pressure sensitive adhesives useful in adhesive articles of the present disclosure include those based on natural rubbers, synthetic rubbers, styrene block copolymers, polyvinyl ethers, acrylics, poly-α-olefins, silicones, polyurethanes or polyureas.

Useful natural rubber pressure sensitive adhesives generally contain masticated natural rubber, from 25 parts to 300 parts of one or more tackifying resins to 100 parts of natural rubber, and typically from 0.5 to 2.0 parts of one or more antioxidants. Natural rubber may range in grade from a light pale crepe grade to a darker ribbed smoked sheet and includes such examples as CV-60, a controlled viscosity rubber grade and SMR-5, a ribbed smoked sheet rubber grade.

Tackifying resins used with natural rubbers generally include, but are not limited to, wood rosin and its hydrogenated derivatives; terpene resins of various softening points, and petroleum-based resins, such as, the “ESCOREZ 1300” series of C5 aliphatic olefin-derived resins from Exxon, and “PICCOLYTE S” series, polyterpenes from Hercules, Inc. Antioxidants are used to retard the oxidative attack on natural rubber, which can result in loss of the cohesive strength of the natural rubber adhesive. Useful antioxidants include, but are not limited to, amines, such as N—N′-di-β-naphthyl-1,4-phenylenediamine, available as “AGERITE D”; phenolics, such as 2,5-di-(t-amyl) hydroquinone, available as “SANTOVAR A”, available from Monsanto Chemical Co., tetrakis[methylene 3-(3′, 5′-di-tert-butyl-4′-hydroxyphenyl)propionate]methane, available as “IRGANOX 1010” from Ciba-Geigy Corp., and 2-2′-methylenebis(4-methyl-6-tert butyl phenol), available as Antioxidant 2246; and dithiocarbamates, such as zinc dithiodibutyl carbamate. Other materials can be added to natural rubber adhesives for special purposes, wherein the additives can include plasticizers, pigments, and curing agents to partially vulcanize the pressure sensitive adhesive.

Another useful class of pressure sensitive adhesives are those comprising synthetic rubber. Such adhesives are generally rubbery elastomers, which are either self-tacky or non-tacky and require tackifiers.

Self-tacky synthetic rubber pressure sensitive adhesives include for example, butyl rubber, a copolymer of isobutylene with less than 3 percent isoprene, polyisobutylene, a homopolymer of isoprene, polybutadiene, such as “TAKTENE 220 BAYER” or styrene/butadiene rubber. Butyl rubber pressure sensitive adhesives often contain an antioxidant such as zinc dibutyldithiocarbamate. Polyisobutylene pressure sensitive adhesives do not usually contain antioxidants. Synthetic rubber pressure sensitive adhesives, which generally require tackifiers, are also generally easier to melt process. They comprise polybutadiene or styrene/butadiene rubber, from 10 parts to 200 parts of a tackifier, and generally from 0.5 to 2.0 parts per 100 parts rubber of an antioxidant such as “IRGANOX 1010”. An example of a synthetic rubber is “AMERIPOL 1011A”, a styrene/butadiene rubber available from BF Goodrich. Tackifiers that are useful include derivatives of rosins such as “FORAL 85”, a stabilized rosin ester from Hercules, Inc., the “SNOWTACK” series of gum rosins from Tenneco, and the “AQUATAC” series of tall oil rosins from Sylvachem; and synthetic hydrocarbon resins such as the “PICCOLYTE A” series, polyterpenes from Hercules, Inc., the “ESCOREZ 1300” series of C5 aliphatic olefin-derived resins, the “ESCOREZ 2000” Series of C₉ aromatic/aliphatic olefin-derived resins, and polyaromatic C₉ resins, such as the “PICCO 5000” series of aromatic hydrocarbon resins, from Hercules, Inc. Other materials can be added for special purposes, including hydrogenated butyl rubber, pigments, plasticizers, liquid rubbers, such as “VISTANEX LMMH” polyisobutylene liquid rubber available from Exxon, and curing agents to vulcanize the adhesive partially.

Styrene block copolymer pressure sensitive adhesives generally comprise elastomers of the A-B or A-B-A type, where A represents a thermoplastic polystyrene block and B represents a rubbery block of polyisoprene, polybutadiene, or poly(ethylene/butylene), and resins. Examples of the various block copolymers useful in block copolymer pressure sensitive adhesives include linear, radial, star and tapered styrene-isoprene block copolymers such as “KRATON D1107P”, available from Shell Chemical Co., and “EUROPRENE SOL TE 9110”, available from EniChem Elastomers Americas, Inc.; linear styrene-(ethylene-butylene) block copolymers such as “KRATON G1657”, available from Shell Chemical Co.; linear styrene-(ethylene-propylene) block copolymers such as “KRATON G1750X”, available from Shell Chemical Co.; and linear, radial, and star styrene-butadiene block copolymers such as “KRATON D1118X”, available from Shell Chemical Co., and “EUROPRENE SOL TE 6205”, available from EniChem Elastomers Americas, Inc. The polystyrene blocks tend to form domains in the shape of spheroids, cylinders, or plates that causes the block copolymer pressure sensitive adhesives to have two-phase structures. Resins that associate with the rubber phase generally develop tack in the pressure sensitive adhesive. Examples of rubber phase associating resins include aliphatic olefin-derived resins, such as the “ESCOREZ 1300” series and the “WINGTACK” series, available from Goodyear; rosin esters, such as the “FORAL” series and the “STAYBELITE” Ester 10, both available from Hercules, Inc.; hydrogenated hydrocarbons, such as the “ESCOREZ 5000” series, available from Exxon; polyterpenes, such as the “PICCOLYTE A” series; and terpene phenolic resins derived from petroleum or terpentine sources, such as “PICCOFYN A100”, available from Hercules, Inc. Resins that associate with the thermoplastic phase tend to stiffen the pressure sensitive adhesive. Thermoplastic phase associating resins include polyaromatics, such as the “PICCO 6000” series of aromatic hydrocarbon resins, available from Hercules, Inc.; coumarone-indene resins, such as the “CUMAR” series, available from Neville; and other high-solubility parameter resins derived from coal tar or petroleum and having softening points above about 85° C., such as the “AMOCO 18” series of alpha-methyl styrene resins, available from Amoco, “PICCOVAR 130” alkyl aromatic polyindene resin, available from Hercules, Inc., and the “PICCOTEX” series of alpha-methyl styrene/vinyltoluene resins, available from Hercules. Other materials can be added for special purposes, including rubber phase plasticizing hydrocarbon oils, such as, “TUFFLO 6056”, available from Lyondell Petrochemical Co., Polybutene-8 from Chevron, “KAYDOL”, available from Witco, and “SHELLFLEX 371”, available from Shell Chemical Co.; pigments; antioxidants, such as “IRGANOX 1010” and “IRGANOX 1076”, both available from Ciba-Geigy Corp., “BUTAZATE”, available from Uniroyal Chemical Co., “CYANOX LDTP”, available from American Cyanamid, and “BUTASAN”, available from Monsanto Co.; antiozonants, such as “NBC”, a nickel dibutyldithiocarbamate, available from DuPont; liquid rubbers such as “VISTANEX LMMH” polyisobutylene rubber; and ultraviolet light inhibitors, such as “IRGANOX 1010” and “TINUVIN P”, available from Ciba-Geigy Corp.

Polyvinyl ether pressure sensitive adhesives are generally blends of homopolymers of vinyl methyl ether, vinyl ethyl ether or vinyl iso-butyl ether, or blends of homopolymers of vinyl ethers and copolymers of vinyl ethers and acrylates to achieve desired pressure sensitive properties. Depending on the degree of polymerization, homopolymers may be viscous oils, tacky soft resins or rubber-like substances. Polyvinyl ethers used as raw materials in polyvinyl ether adhesives include polymers based on: vinyl methyl ether such as “LUTANOL M 40”, available from BASF, and “GANTREZ M 574” and “GANTREZ 555”, available from ISP Technologies, Inc.; vinyl ethyl ether such as “LUTANOL A 25”, “LUTANOL A 50” and “LUTANOL A 100”; vinyl isobutyl ether such as “LUTANOL 130”, “LUTANOL 160”, “LUTANOL IC”, “LUTANOL I60D” and “LUTANOL I 65D”; methacrylate/vinyl isobutyl ether/acrylic acid such as “ACRONAL 550 D”, available from BASF. Antioxidants useful to stabilize the polyvinylether pressure sensitive adhesive include, for example, “IONOX 30” available from Shell, “IRGANOX 1010” available from Ciba-Geigy, and antioxidant “ZKF” available from Bayer Leverkusen. Other materials can be added for special purposes as described in BASF literature including tackifiers, plasticizers and pigments.

Acrylic pressure sensitive adhesives generally have a glass transition temperature of about −20° C. or less and may comprise from 100 to 80 weight percent of a C₃-C₁₂ alkyl ester component such as, for example, isooctyl acrylate, 2-ethylhexyl acrylate and n-butyl acrylate and from 0 to 20 weight percent of a polar component such as, for example, acrylic acid, methacrylic acid, ethylene-vinyl acetate units, N-vinylpyrrolidone, and styrene macromer. Generally, the acrylic pressure sensitive adhesives comprise from 0 to 20 weight percent of acrylic acid and from 100 to 80 weight percent of isooctyl acrylate. The acrylic pressure sensitive adhesives may be self-tacky or tackified. Useful tackifiers for acrylics are rosin esters such as “FORAL 85”, available from Hercules, Inc., aromatic resins such as “PICCOTEX LC-55WK”, aliphatic resins such as “PICCOTAC 95”, available from Hercules, Inc., and terpene resins such as α-pinene and β-pinene, available as “PICCOLYTE A-115” and “ZONAREZ B-100” from Arizona Chemical Co. Other materials can be added for special purposes, including hydrogenated butyl rubber, pigments, and curing agents to vulcanize the adhesive partially.

Poly-α-olefin pressure sensitive adhesives, also called a poly(l-alkene) pressure sensitive adhesives, generally comprise either a substantially uncrosslinked polymer or an uncrosslinked polymer that may have radiation activatable functional groups grafted thereon as described in U.S. Pat. No. 5,209,971 (Babu, et al). The poly-α-olefin polymer may be self tacky and/or include one or more tackifying materials. If uncrosslinked, the inherent viscosity of the polymer is generally between about 0.7 and 5.0 dL/g as measured by ASTM D 2857-93, “Standard Practice for Dilute Solution Viscosity of Polymers”. In addition, the polymer generally is predominantly amorphous. Useful poly-α-olefin polymers include, for example, C₃-C₁₈ poly(l-alkene) polymers, generally C₅-C₁₂ α-olefins and copolymers of those with C₃ or C₆-C₈ and copolymers of those with C₃. Tackifying materials are typically resins that are miscible in the poly-α-olefin polymer. The total amount of tackifying resin in the poly-α-olefin polymer ranges from 0 to 150 parts by weight per 100 parts of the poly-α-olefin polymer depending on the specific application. Useful tackifying resins include resins derived by polymerization of C₅ to C₉ unsaturated hydrocarbon monomers, polyterpenes, synthetic polyterpenes and the like. Examples of such commercially available resins based on a C₅ olefin fraction of this type are “WINGTACK 95” and “WINGTACK 15” tackifying resins available from Goodyear Tire and Rubber Co. Other hydrocarbon resins include “REGALREZ 1078” and “REGALREZ 1126” available from Hercules Chemical Co., and “ARKON P115” available from Arakawa Chemical Co. Other materials can be added for special purposes, including antioxidants, fillers, pigments, and radiation activated crosslinking agents.

Silicone pressure sensitive adhesives comprise two major components, a polymer or gum, and a tackifying resin. The polymer is typically a high molecular weight polydimethylsiloxane or polydimethyldiphenylsiloxane, that contains residual silanol functionality (SiOH) on the ends of the polymer chain, or a block copolymer comprising polydiorganosiloxane soft segments and urea or oxamide terminated hard segments. The tackifying resin is generally a three-dimensional silicate structure that is endcapped with trimethylsiloxy groups (OSiMe₃) and also contains some residual silanol functionality. Examples of tackifying resins include SR 545, from General Electric Co., Silicone Resins Division, Waterford, N.Y., and MQD-32-2 from Shin-Etsu Silicones of America, Inc., Torrance, Calif. Manufacture of typical silicone pressure sensitive adhesives is described in U.S. Pat. No. 2,736,721 (Dexter). Manufacture of silicone urea block copolymer pressure sensitive adhesive is described in U.S. Pat. No. 5,214,119 (Leir, et al). Other materials can be added for special purposes, including pigments, plasticizers, and fillers. Fillers are typically used in amounts from 0 parts to 10 parts per 100 parts of silicone pressure sensitive adhesive. Examples of fillers that can be used include zinc oxide, silica, carbon black, pigments, metal powders and calcium carbonate. One particularly suitable class or siloxane-containing pressure sensitive adhesives are those with oxamide terminated hard segments such as those described in U.S. Pat. No. 7,981,995 (Hays) and U.S. Pat. No. 7,371,464 (Sherman).

Polyurethane and polyurea pressure sensitive adhesives useful in this disclosure include, for example, those disclosed in WO 00/75210 (Kinning et al.) and in U.S. Pat. No. 3,718,712 (Tushaus); U.S. Pat. No. 3,437,622 (Dahl); and U.S. Pat. No. 5,591,820 (Kydonieus et al.).

One class of pressure sensitive adhesives that is particularly suitable is optically clear adhesives. In some embodiments, the optically clear adhesive has a % Transmission of 95% or greater, or even 99% or greater. Also, in some embodiments the optically clear adhesive has a haze value of 3% or less, or even 1% or less. In some embodiments the optically clear adhesive has a clarity value of 99% or greater. In some embodiments, the adhesive is an optically clear pressure sensitive adhesive. The pressure sensitive adhesive component can be a single pressure sensitive adhesive or the pressure sensitive adhesive can be a combination of two or more pressure sensitive adhesives.

Optically clear pressure sensitive adhesives useful in the present disclosure include, for example, those based on natural rubbers, synthetic rubbers, styrene block copolymers, (meth)acrylic block copolymers, polyvinyl ethers, polyolefins, and poly(meth)acrylates. The terms (meth)acrylate and (meth)acrylic include both acrylates and methacrylates.

One particularly suitable class of optically clear pressure sensitive adhesives is (meth)acrylate-based pressure sensitive adhesives and may comprise either an acidic or basic copolymer. In many embodiments the (meth)acrylate-based pressure sensitive adhesive is an acidic copolymer. Generally, as the proportion of acidic monomers used in preparing the acidic copolymer increases, cohesive strength of the resulting adhesive increases. The proportion of acidic monomers is usually adjusted depending on the proportion of acidic copolymer present in the blends of the present disclosure.

To achieve pressure sensitive adhesive characteristics, the corresponding copolymer can be tailored to have a resultant glass transition temperature (Tg) of less than about 0° C. Particularly suitable pressure sensitive adhesive copolymers are (meth)acrylate copolymers. Such copolymers typically are derived from monomers comprising about 40% by weight to about 98% by weight, often at least 70% by weight, or at least 85% by weight, or even about 90% by weight, of at least one alkyl (meth)acrylate monomer that, as a homopolymer, has a Tg of less than about 0° C.

Examples of such alkyl (meth)acrylate monomers are those in which the alkyl groups comprise from about 4 carbon atoms to about 12 carbon atoms and include, but are not limited to, n-butyl acrylate, 2-ethylhexyl acrylate, isooctyl acrylate, isononyl acrylate, isodecyl acrylate, and mixtures thereof. Optionally, other vinyl monomers and alkyl (meth)acrylate monomers which, as homopolymers, have a Tg greater than 0° C., such as methyl acrylate, methyl methacrylate, isobornyl acrylate, vinyl acetate, styrene, and the like, may be utilized in conjunction with one or more of the low Tg alkyl (meth)acrylate monomers and copolymerizable basic or acidic monomers, provided that the Tg of the resultant (meth)acrylate copolymer is less than about 0° C.

In some embodiments, it is desirable to use (meth)acrylate monomers that are free of alkoxy groups. Alkoxy groups are understood by those skilled in the art.

When used, basic (meth)acrylate copolymers useful as the pressure sensitive adhesive matrix typically are derived from basic monomers comprising about 2% by weight to about 50% by weight, or about 5% by weight to about 30% by weight, of a copolymerizable basic monomer. Exemplary basic monomers include N,N-dimethylaminopropyl methacrylamide (DMAPMAm); N,N-diethylaminopropyl methacrylamide (DEAPMAm); N,N-dimethylaminoethyl acrylate (DMAEA); N,N-diethylaminoethyl acrylate (DEAEA); N,N-dimethylaminopropyl acrylate (DMAPA); N,N-diethylaminopropyl acrylate (DEAPA); N,N-dimethylaminoethyl methacrylate (DMAEMA); N,N-diethylaminoethyl methacrylate (DEAEMA); N,N-dimethylaminoethyl acrylamide (DMAEAm); N,N-dimethylaminoethyl methacrylamide (DMAEMAm); N,N-diethylaminoethyl acrylamide (DEAEAm); N,N-diethylaminoethyl methacrylamide (DEAEMAm); N,N-dimethylaminoethyl vinyl ether (DMAEVE); N,N-diethylaminoethyl vinyl ether (DEAEVE); and mixtures thereof. Other useful basic monomers include vinylpyridine, vinylimidazole, tertiary amino-functionalized styrene (e.g., 4-(N,N-dimethylamino)-styrene (DMAS), 4-(N,N-diethylamino)-styrene (DEAS)), N-vinylpyrrolidone, N-vinylcaprolactam, acrylonitrile, N-vinylformamide, (meth)acrylamide, and mixtures thereof.

When used to form the pressure sensitive adhesive matrix, acidic (meth)acrylate copolymers typically are derived from acidic monomers comprising about 2% by weight to about 30% by weight, or about 2% by weight to about 15% by weight, of a copolymerizable acidic monomer. Useful acidic monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, beta-carboxyethyl acrylate, 2-sulfoethyl methacrylate, styrenesulfonic acid, 2-acrylamido-2-methylpropanesulfonic acid, vinylphosphonic acid, and the like, and mixtures thereof. Due to their availability, typically ethylenically unsaturated carboxylic acids are used.

In certain embodiments, the poly(meth)acrylic pressure sensitive adhesive matrix is derived from between about 1 and about 20 weight percent of acrylic acid and between about 99 and about 80 weight percent of at least one of isooctyl acrylate, 2-ethylhexyl acrylate or n-butyl acrylate composition. In some embodiments, the pressure sensitive adhesive matrix is derived from between about 2 and about 10 weight percent acrylic acid and between about 90 and about 98 weight percent of at least one of isooctyl acrylate, 2-ethylhexyl acrylate or n-butyl acrylate composition.

Another useful class of optically clear (meth)acrylate-based pressure sensitive adhesives are those which are (meth)acrylic block copolymers. Such copolymers may contain only (meth)acrylate monomers or may contain other co-monomers such as styrenes. Examples of such pressure sensitive adhesives are described, for example in U.S. Pat. No. 7,255,920 (Everaerts et al.).

The pressure sensitive adhesive may be inherently tacky. If desired, tackifiers may be added to a base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, curing agents, polymer additives, thickening agents, chain transfer agents and other additives provided that they do not reduce the optical clarity of the pressure sensitive adhesive.

In some embodiments it is desirable for the composition to contain a crosslinking agent. The choice of crosslinking agent depends upon the nature of polymer or copolymer which one wishes to crosslink. The crosslinking agent is used in an effective amount, by which is meant an amount that is sufficient to cause crosslinking of the pressure sensitive adhesive to provide adequate cohesive strength to produce the desired final adhesion properties to the substrate of interest. Generally, when used, the crosslinking agent is used in an amount of about 0.1 part to about 10 parts by weight, based on the total amount of monomers.

One class of useful crosslinking agents includes multifunctional (meth)acrylate species. Multifunctional (meth)acrylates include tri(meth)acrylates and di(meth)acrylates (that is, compounds comprising three or two (meth)acrylate groups). Typically di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

Another useful class of crosslinking agents contains functionality which is reactive with carboxylic acid groups on the acrylic copolymer. Examples of such crosslinkers include multifunctional aziridine, isocyanate and epoxy compounds. Examples of aziridine-type crosslinkers include, for example 1,4-bis(ethyleneiminocarbonylamino)benzene, 4,4′-bis(ethyleneiminocarbonylamino)diphenylmethane, 1,8-bis(ethyleneiminocarbonylamino)octane, and 1,1′-(1,3-phenylene dicarbonyl)-bis-(2-methylaziridine). The aziridine crosslinker 1,1′-(1,3-phenylene dicarbonyl)-bis-(2-methylaziridine) (CAS No. 7652-64-4), referred to herein as “Bisamide” is particularly useful. Common polyfunctional isocyanate crosslinkers include, for example, trimethylolpropane toluene diisocyanate, tolylene diisocyanate, and hexamethylene diisocyanate.

The adhesive, or the reactive mixture which upon polymerization forms the adhesive, may be coated onto a surface to form the adhesive layer. For example, the adhesive can be applied to films or sheeting products (e.g., optical, decorative, reflective, and graphical), labelstock, tape backings, release liners, and the like. The substrate can be any suitable type of material depending on the desired application.

The adhesive layer can be formed by either continuous or batch processes. An example of a batch process is the placement of a portion of the adhesive between a substrate to which the film or coating is to be adhered and a surface capable of releasing the adhesive film or coating to form a composite structure. The composite structure can then be compressed at a sufficient temperature and pressure to form an adhesive layer of a desired thickness after cooling. Alternatively, the adhesive can be compressed between two release surfaces and cooled to form an adhesive transfer tape useful in laminating applications.

Continuous forming methods include drawing the adhesive out of a film die and subsequently contacting the drawn adhesive to a moving plastic web or other suitable substrate. A related continuous method involves extruding the adhesive and a coextruded backing material from a film die and cooling the layered product to form an adhesive tape. Other continuous forming methods involve directly contacting the adhesive to a rapidly moving plastic web or other suitable preformed substrate. Using this method, the adhesive is applied to the moving preformed web using a die having flexible die lips, such as a rotary rod die. After forming by any of these continuous methods, the adhesive films or layers can be solidified by quenching using both direct methods (e.g., chill rolls or water baths) and indirect methods (e.g., air or gas impingement).

Adhesives can also be coated using a solvent-based or aqueous-based (that is to say a solvent-based method comprising water or a solvent mixture including water as the solvent) method. For example, the adhesive can be coated by such methods as knife coating, roll coating, gravure coating, rod coating, curtain coating, and air knife coating. The adhesive mixture may also be printed by known methods such as screen printing or inkjet printing. The coated solvent-based or aqueous-based adhesive is then dried to remove the solvent. Typically, the coated solvent-based or aqueous-based adhesive is subjected to elevated temperatures, such as those supplied by an oven, to expedite drying of the adhesive.

The thickness of the adhesive layer tends to be at least about 1 micrometer, at least 5 micrometers, at least 10 micrometers, at least 15 micrometers, or at least 20 micrometers. The thickness is often no greater than about 200 micrometers, no greater than about 175 micrometers, no greater than about 150 micrometers, or no greater than about 125 micrometers. For example, the thickness can be 1 to 200 micrometers, 5 to 100 micrometers, 10 to 50 micrometers, 20 to 50 micrometers, or 1 to 15 micrometers.

A plurality of non-pressure sensitive adhesive structures are formed on the surface of the pressure sensitive adhesive layer by contact printing. A variety of contact printing techniques are suitable, as is well known by one of skill in the art. Among the useful direct contact printing techniques are flexographic printing, patterned roll coating, letterpress printing, lithography, stencil printing, and the like. The method of contact printing used to deposit the non-pressure sensitive adhesive structures on the surface of the pressure sensitive adhesive layer should be chosen such that the printing technique does not embed the non-pressure sensitive adhesive structures into the adhesive layer. In particular it is desirable that the printing technique used does not involve the contacting of the printing tool surface to the pressure sensitive adhesive layer surface, but rather that a layer of fluid to be printed be present between the tool surface and the pressure sensitive adhesive surface. Evidence that this is the case is the observation that, upon removal of the tool from the pressure sensitive adhesive surface, some of the printed fluid remains on the pressure sensitive adhesive surface and some of the printed fluid remains on the surface of the tool. In other words, when a layer of fluid is printed on the pressure sensitive adhesive surface with a contact printing tool, removal of the tool from the pressure sensitive adhesive surface causes the fluid layer to split, leaving some of the fluid on the pressure sensitive adhesive surface and some on the printing tool surface. This splitting of the fluid layer indicates that at least a portion of the fluid layer has remained between the tool surface and the pressure sensitive adhesive surface and that the tool surface has not contacted the pressure sensitive adhesive surface.

One particularly suitable method of contact printing is flexographic printing. A flexographic printing apparatus typically includes a flexographic printing plate which may be mounted e.g. onto the exterior surface of a printing cylinder (or which, in some embodiments, may itself be supplied in cylindrical form). An anilox roll may be provided which may receive a liquid into cells of the exterior surface of the anilox roll. Movement (e.g., rotation) of anilox roll and printing cylinder causes the liquid to be transferred (in a metered amount) from cells of the anilox roll, onto printing surfaces of the flexographic printing plate. Continued movement (e.g., rotation) of printing cylinder causes the liquid to be transferred from printing surfaces of flexographic printing plate onto the first major surface of the pressure sensitive adhesive layer.

In some embodiments, the flexographic printing plate may be processed as a flat plate to impart it with a desired printing pattern, and then curved and fitted onto the exterior surface of printing cylinder if desired. In some embodiments, the flexographic printing plate may be provided in cylindrical form rather than as a flat plate that may be eventually wrapped around a printing cylinder. In other general types of embodiments, the flexographic printing plate may be provided by molding a flexographic plate precursor material against a master mold whose surface contains a relief pattern that is complementary to the relief pattern that is desired to be provided in plate material. The molding process will thus produce a flexographic plate material with the desired relief structure. Such a plate precursor material may be any suitable flowable (moldable) material, whether thermoplastic, thermoset, and so on, as will be well understood by the ordinary artisan. In a variation of such approaches, an embossable plate precursor material may be used, which, while it may not necessarily approach such low viscosity as e.g. a moldable material, nevertheless will soften sufficiently upon being heated to allow the desired relief pattern to be formed therein, which pattern is maintained upon cooling of the embossable plate precursor material.

Other suitable types of contact printing include patterned roll coating, letterpress printing, lithography, stencil printing, and the like. Patterned roll coating is similar to flexographic printing in that a roll with pattern on its surface is coated with coating mixture and contacted to the surface of the pressure sensitive adhesive. Letterpress printing is a method of relief printing in which a pattern is formed in the bed of the press, the pattern is covered with a coating mixture such as an ink, and the surface of the pressure sensitive adhesive is pressed against the coated structured surface. Lithography is a suitable process for applying hydrophobic coating mixtures. A pattern is formed on the lithographic plate which is the mirror image of the pattern to be transferred. The plate is affixed to a cylinder on a printing press, dampening rollers apply water which covers the blank portions of the plate but is repelled by the patterned regions of the plate. A hydrophobic coating mixture, such as a hydrophobic ink is applied by inking rollers, and the hydrophobic coating mixture is repelled by the water and only adheres to the patterned areas. The plate is then contacted to the pressure sensitive adhesive surface and the hydrophobic coating mixture is transferred to the surface. Stencil printing is similar to the printing types already described except that a stencil is used as the pattern.

Whatever contact printing technique is chosen it is desirable that the printing technique not embed the non-pressure sensitive material into the pressure sensitive adhesive layer, but rather that the non-pressure sensitive adhesive material remain on the surface of the pressure sensitive adhesive layer. There are a number of reasons for not wishing to embed the non-pressure sensitive adhesive material into the pressure sensitive adhesive layer. Since the printing of non-pressure sensitive adhesive material is designed to modify only the surface of the pressure sensitive adhesive layer, it is desirable to not modify the bulk of the pressure sensitive adhesive layer. Embedding the non-pressure sensitive adhesive material into the pressure sensitive adhesive layer modifies the bulk of the pressure sensitive adhesive layer. Additionally, as has been described above, in some embodiments, when the pressure sensitive adhesive layer is bonded to the surface of an adherend, the non-pressure sensitive adhesive material is pressed into the pressure sensitive layer to permit the formation of a strong adhesive bond. The presence of the non-pressure sensitive adhesive material in the pressure sensitive adhesive layer can detrimentally affect the properties of the pressure sensitive adhesive layer. Among the affected are not only the adhesive properties of peel strength, shear holding power, and tack, but also additional properties such as optical properties. Therefore, it is desirable that the amount of non-pressure sensitive adhesive material that is applied to provide positionability and repositionability is minimized to limit the affect on the properties of the pressure sensitive adhesive layer. If the non-pressure sensitive adhesive material is embedded in the pressure sensitive adhesive layer at the time of printing or when a release liner is applied to the pressure sensitive adhesive layer, a much larger amount of non-pressure sensitive adhesive material must be applied to obtain the same effect. For example, if it is desired to modify a 51 micrometer thick (2 mils) pressure sensitive adhesive layer with non-pressure sensitive adhesive material projections that project above the adhesive layer by 5 micrometers to provide positionability and repositionability, the amount of material that must be printed onto the pressure sensitive adhesive layer is much greater if the non-pressure sensitive adhesive material is embedded in the pressure sensitive adhesive layer than if the non-pressure sensitive adhesive material is located on the surface of the pressure sensitive adhesive layer. If the non-pressure sensitive adhesive material is embedded by 50%, twice as much material is required to achieve the same 5 micrometer projections above the adhesive surface as is required if the non-pressure sensitive adhesive material is located at the surface of the pressure sensitive adhesive layer.

Additionally, in the embodiments where the surface modification is a temporary effect (for example, positionability or repositionability) upon lamination of the pressure sensitive adhesive layer to an adherend surface, it is desirable that the non-pressure sensitive adhesive material become entrapped in the pressure sensitive adhesive layer. Typically, pressure applied to the laminate forces the non-pressure sensitive adhesive material into the bulk of the pressure sensitive adhesive layer. The smaller the amount of non-pressure sensitive adhesive material present, the easier it is to effect this entrapment of the non-pressure sensitive adhesive material in the pressure sensitive adhesive layer. And once the non-pressure sensitive adhesive material is entrapped in the pressure sensitive adhesive layer, the smaller the amount of non-pressure sensitive adhesive material present, the smaller the effect it will have on the properties of the pressure sensitive adhesive layer, as was discussed above.

Thus it is desirable to minimize the amount of non-pressure sensitive adhesive material needed to produce the surface modification effects such as positionability and repositionability. Not embedding the non-pressure sensitive adhesive material in the pressure sensitive adhesive layer minimizes the amount of non-pressure sensitive adhesive material necessary to effect surface modification.

As mentioned above, in some embodiments it is desirable that the non-pressure sensitive adhesive material remain at the surface to permanently modify the surface of the pressure sensitive adhesive layer. In these embodiments it is particularly desirable that the non-pressure sensitive adhesive material not become embedded in the pressure sensitive adhesive layer as the non-pressure sensitive adhesive material is designed to remain at the surface and embedding in the pressure sensitive adhesive layer can inhibit this surface modification effect and lead to a loss of the desired surface property modification if the non-pressure sensitive adhesive material becomes too deeply embedded.

Each of the above printing techniques can be used to apply a material to the surface of the pressure sensitive adhesive layer in a pattern, either a regular pattern or a random pattern. The material that is applied to the surface of the pressure sensitive adhesive layer can take a wide variety of forms. The material can be a 100% solids composition, a mixture of liquid and solid, a curable composition, or an ink. Compositions that are 100% solids are free or essentially free of solvents. Additionally, a wide variety of material compositions are suitable, for example, the material may comprise an elastomeric material, a thermoplastic material, or a curable material. Curable materials include materials that upon curing are can be thermoset materials, thermoplastic materials, or elastomeric materials.

Exemplary materials include resins, polymeric materials, dyes, inks, vinyl, inorganic materials, UV-curable polymers, pigments, particles, beads and combinations thereof. Particularly suitable are polymeric materials and UV-curable polymeric materials. Among the suitable polymeric materials are olefinic materials such as polyethylene and polypropylene, polyurethane and polyurea materials, (meth)acrylate materials such polymethylmethacrylate (PMMA), polyester materials such as polyethyleneterephthalate (PET), and the like. Examples of UV-curable polymeric materials include a wide range of (meth)acrylate materials. These curable (meth)acrylate materials include (meth)acrylate monomers and oligomers, vinyl functional monomers and oligomers, such as vinyl esters and styrenes, urethane (meth)acrylates, and the like. In some embodiments, the polymeric material may be a heat activated adhesive. In this way, the heat activated adhesive structures, which are not tacky at room temperature, can serve as non-adhesive structures at room temperature but upon heating can become adhesive structures.

The polymeric materials and UV-curable polymeric materials can contain additives or fillers. These additives and fillers can include plasticizing resins, tackifying resins, antibacterial agents, stabilizers (such as thermal or UV stabilizers), colorants (such as pigments and dyes), and particulate fillers such as carbon black, silica, titania, glass microspheres, calcium carbonate, and the like.

In some embodiments, particularly optical embodiments, it may be desirable that the polymeric material or the UV-curable polymeric material have a refractive index which is similar to the refractive index of the pressure sensitive adhesive layer. In this way, the polymeric material or the UV-curable polymeric material, whether on the surface or submerged in the pressure sensitive adhesive layer, will not adversely affect the optical properties of the pressure sensitive adhesive layer. Whenever light contacts an interface between materials with different refractive indices, the light is refracted. By minimizing the difference in refractive index between the polymeric material or the UV-curable polymeric material and the pressure sensitive adhesive layer, this refraction can be reduced or eliminated. Typically the difference in refractive index between the polymeric material or the UV-curable polymeric material and the pressure sensitive adhesive layer is 0.02 or less, in some embodiments 0.15 or less.

Additionally, in optical applications it is desirable to eliminate the moiré effect. The moiré effect results from the interference among two or more regular structures having different intrinsic frequencies. For example, a moiré effect is observed as an interference phenomenon when two similar lattices are overlapped. Although the moiré effect is advantageously utilized in the field of measuring apparatuses and medical instruments, the moiré effect causes significant degradation in performance in display devices. The non-pressure sensitive adhesive structures of the present disclosure do not display the moiré effect.

The material may be applied to the surface of the pressure sensitive adhesive layer in any desired pattern of structures. The pattern may be regular or it may be random. The pattern can comprise structures of a single shape, a variety of shapes, and it can be arranged in such a way that the pattern forms an image. Examples of images include, for example, logos and indicia.

Examples of suitable structure shapes include hemispheres, prisms (such as square prisms, rectangular prisms, cylindrical prisms and other similar polygonal features), pyramids, ellipses, and the like. Typically the structural shapes are discrete (meaning that the shapes are not connected or not all connected) and of a surface area that is small relative to the surface area of the pressure sensitive adhesive layer. Additionally, it is desirable that the cumulative surface area of the non-pressure sensitive adhesive structures be sufficiently small relative to the surface area of the pressure sensitive adhesive layer that the pressure sensitive adhesive properties of the pressure sensitive adhesive layer are not seriously mitigated or eliminated. Generally the surface area of the non-pressure sensitive adhesive structures occupy less than 60% of the surface area of the pressure sensitive adhesive layer, or less than 40% of the pressure sensitive adhesive layer, or less than 20%, more typically less than 10% of the surface area of the pressure sensitive adhesive layer. In some embodiments the surface area of the non-pressure sensitive adhesive structures occupies less than 10% of the surface area of the pressure sensitive adhesive layer. The surface area occupied by the non-pressure sensitive adhesive structures and the size of the individual structures themselves can vary depending upon the intended use of the surface modified adhesive. Typically, the surface area of individual structures is very small relative to the surface area of the pressure sensitive adhesive layer.

Typically the dry thickness of the material applied to the surface of the pressure sensitive adhesive layer is small relative to the thickness of the pressures sensitive adhesive layer itself. This is because the material is designed to modify the surface properties of the pressure sensitive adhesive layer. Thus the dry thickness of the material applied to the surface of the pressure sensitive adhesive layer is typically less than 50% of the thickness of the pressure sensitive adhesive layer, more typically less than 40% of the thickness of the pressure sensitive adhesive layer, or less than 30% of the thickness of the pressure sensitive adhesive layer, or even less than 20% of the thickness of the pressure sensitive adhesive layer.

In some embodiments, the material applied the surface of the pressure sensitive adhesive layer comprises an ink, a paste, or a 100% solids composition comprising a conductive metal. Examples include inks, where the ink is a dispersion of conductive metal in a solvent, pastes containing dispersed conductive metal, and 100% solids mixtures containing conductive metal particles. When the composition is applied to the surface of the pressure sensitive adhesive layer and dried if necessary, it can form a circuit. By a circuit, it is meant that the material applied to the surface of the pressure sensitive adhesive layer forms a substantially continuous electrically conductive layer. The term “substantially continuous electrically conductive layer” as used herein refers to a continuous layer of electrically conductive polymer, electrically conductive particles or a combination thereof, disposed on a releasing substrate. The term “electrically conductive layer” as used herein refers to a continuous or discontinuous layer on an adhesive layer that has conductive or antistatic properties. The terms “conductive” or “antistatic” mean that the concentration of conductive or antistatic particles at the adhesive surface is above the percolation threshold. The percolation threshold may be viewed as the point at which a dramatic drop in resistivity is observed for the adhesive layer, indicative of sufficient conductive particle concentration in the adhesive surface to provide a conductive pathway.

Compositions suitable for forming circuits include the silver-based inks and nanopastes commercially available from Harima Chemicals, DIC/Sun Chemical, DuPont, Ferro, Henkel, Heraeus, Ink-Tec, Methode, and others.

Typically, when circuits are formed on the surface of the pressure sensitive adhesive layer, the circuits remain at the surface of the pressure sensitive adhesive layer, they do not become immersed in the pressure sensitive adhesive layer.

After the non-pressure sensitive adhesive material is applied to the surface of the pressure sensitive adhesive layer, additional processing steps may be carried out, such as drying, curing or a combination thereof, depending upon the nature of the material deposited. Drying and/or curing can be carried out through the application of heat, or radiation (such as UV radiation) or by a combination thereof. Heat can be applied, for example, through the use of an oven or through the use of an IR lamp.

In some embodiments, a second printing step can be carried out. In this second printing step, additional material can be added to the pressure sensitive adhesive or additional material can be added to the non-pressure sensitive adhesive material already present on the pressure sensitive adhesive layer surface. The material printed in the second printing can be the same as the material printed in the first printing step, or in some desirable embodiments the material printed in the second printing is different from the material printed in the first printing step. Additionally, the printing process for the second printing step may be the same as in the first or it may be different printing method. By different printing method it is meant to include not only a different contact printing method but also other printing methods such as inkjet printing, screen printing and the like. In this way, the non-pressure sensitive adhesive material printed in the first printing step can form a platform onto which the material of the second printing step is printed. In this way, materials that may be unsuitable or difficult to print onto the pressure sensitive adhesive layer can be printed instead onto the non-pressure sensitive adhesive material. For example, if one wanted to print a discontinuous colored pattern onto the surface of the pressure sensitive adhesive but found it undesirable to print the colored ink onto the pressure sensitive adhesive layer directly (either because it is difficult to print the ink by the direct contact printing methods of this disclosure, or because one did not wish to print the amount of colored ink necessary to form the structures of non-pressure sensitive adhesive material useful in the printing methods of this disclosure, for example) one could form non-pressure sensitive adhesive structures on the pressure sensitive adhesive layer by the direct contact printing methods of this disclosure and then inkjet print a very thin layer of colored ink on the surface of the non-pressure sensitive adhesive structures via inkjet printing. In this way the desirable features of the non-pressure sensitive adhesive structures can be combined with a discontinuous colored pattern. Also, it is possible to make more complex structures on the pressure sensitive adhesive surface by printing in multiple steps. For example, rather than printing a conductive ink onto a pressure sensitive adhesive layer, one could make non-pressure sensitive adhesive structures on the surface of the pressure sensitive adhesive layer and then print a conductive ink onto the surface of the non-pressure sensitive adhesive structures. In this way the non-pressure sensitive adhesive structures can act as platforms on which to form circuits or other conductive elements. One advantage to this approach is that even if the platforms become pressed into the pressure sensitive adhesive layer, the conductive elements can remain at the pressure sensitive adhesive surface.

The adhesive articles of this disclosure may also comprise a protective sheet to cover the first major surface of the pressure sensitive adhesive layer and the plurality of non-pressure sensitive adhesive structures to facilitate handling of the adhesive article and to protect the structures from being pressed into the pressure sensitive adhesive surface prematurely. In some embodiments the protective sheet comprises a microstructured release liner, in other embodiments, the protective sheet comprises a conformable sheet or a conformable coating on a sheet. In embodiments with a microstructured release liner, the microstructured release liner contains a plurality of depressions, such that at least some of the depressions are aligned with non-pressure sensitive adhesive structures. In this way the depressions of the microstructured release liner protect the non-pressure sensitive adhesive structures and prevent the non-pressure sensitive adhesive structures from being submerged in the pressure sensitive adhesive layer prematurely, that is to say, prior to time when one wishes for the non-pressure sensitive adhesive structures to be submerged in the pressure sensitive adhesive layer. For example, the use of a flat release liner, that is to say one that does not have a microstructured pattern located on its surface, can cause the non-pressure sensitive adhesive structures to be submerged in the pressure sensitive adhesive layer prematurely. While it may be desirable to use a microstructured release liner that has depressions arranged in such a way that each non-pressure sensitive adhesive structure corresponds to a depression in the release liner, such a correspondence is not necessary, as long as some non-pressure sensitive adhesive structures correspond to depressions in the release liner. In this way, a wide range of microstructured release liners can be used and special microstructured release liners need not be prepared for each adhesive article with a plurality of non-pressure sensitive adhesive structures located on the pressure sensitive adhesive surface.

Micro structured release liners are well-known in the adhesive arts. They may be prepared by a variety of processes including, for example, embossing, depositing, or extrusion processes. Typically, microstructured release liners are prepared by embossing a release liner with an embossable surface to a structured tool to impart a structured surface to the release liner. A structured tool is an implement for imparting a structure or finish to a surface and which may be continuously reused in the process. Typically, the structured tool is a molding tool. Structured molding tools can be in the form of a planar stamping press, a flexible or inflexible belt, or a roller. Furthermore, molding tools are generally considered to be tools from which the structured pattern is generated in the surface by embossing, coating, casting, or platen pressing and do not become part of the finished article. In many embodiments, the structured tool is a microstructured tool, meaning that the tool has a microstructured pattern on its surface.

A broad range of methods are known to those skilled in this art for generating microstructured molding tools. Examples of these methods include but are not limited to photolithography, etching, discharge machining, ion milling, micromachining, and electroforming. Microstructured molding tools can also be prepared by replicating various microstructured surfaces, including irregular shapes and patterns, with a moldable material such as those selected from the group consisting of crosslinkable liquid silicone rubber, radiation curable urethanes, etc. or replicating various microstructures by electroforming to generate a negative or positive replica intermediate or final embossing tool mold. Also, microstructured molds having random and irregular shapes and patterns can be generated by chemical etching, sandblasting, shot peening or sinking discrete structured particles in a moldable material. Additionally any of the microstructured molding tools can be altered or modified according to the procedure taught in U.S. Pat. No. 5,122,902 (Benson). The tools may be prepared from a wide range of materials including metals such as nickel, copper, steel, or metal alloys, or polymeric materials.

Typically the embossable surface is a polymeric release liner or a polymeric or paper release liner with a coating of release material on it. This embossable surface is contacted to the microstructured molding tool under conditions of heat and pressure to form the microstructured release surface. Examples of such microstructured release surfaces and patterns can be those found, for example, in PCT Publications Nos. WO 00/69985 and WO 95/11945, and U.S. Pat. No. 5,141,790.

In embodiments where the protective sheet is a conformable sheet or comprises a conformable coating, a wide range of sheets and materials are suitable. The conformable sheet or coating has a relatively low modulus and thus when the conformable surface contacts the plurality of non-pressure sensitive adhesive structures, the conformable surface conforms to the structures rather than pressing the structures into the pressure sensitive adhesive layer. In some embodiments, it may be desirable that the conformable sheet or coating be heated prior to or during application to the pressure sensitive adhesive layer. Such heating can soften the conformable sheet or coating and aid in the conformable sheet or coating surface conforming to the non-pressure sensitive adhesive structures rather than pressing the non-pressure sensitive adhesive structures into the pressure sensitive adhesive layer. Examples of protective sheets that are conformable sheets or comprise conformable coatings are described for example in PCT Publication WO 2010/021796. Typically, it is also desirable for the conformable sheet or coating to have a low surface energy to limit adhesion to the pressure sensitive adhesive layer.

In some embodiments, it may be desirable for the adhesive article to have both major surfaces be surface modified. In these embodiments, not only is the first major surface of the pressure sensitive adhesive layer modified as described above, but also the second major surface of the pressure sensitive adhesive layer. These adhesive articles include ones where the second major surface of the pressure sensitive layer comprises a plurality of non-pressure sensitive adhesive structures disposed on the second major surface of the pressure sensitive adhesive layer, the plurality of non-pressure sensitive adhesive structures being arrayed in a random or non-random pattern, wherein the non-pressure sensitive adhesive structures are applied to the first major surface of the pressure sensitive adhesive layer by direct contact printing, and the substrate that is contact with the second major surface of the pressure sensitive adhesive layer comprises a microstructured release liner.

In some embodiments, the adhesive articles described herein are positionable and/or repositionable. As described above, positionable pressure sensitive adhesive articles are those in which the pressure sensitive adhesive surface has sufficiently low tack as to allow the pressure sensitive adhesive to be slid across the surface of a substrate to which it is to be adhered without sticking or grabbing. The term positionable is used synonymously with the term “slideable”. Similarly, repositionable pressure sensitive adhesive articles are those in which the pressure sensitive adhesive has relatively low initial adhesion (permitting temporary removability from and repositionability on a substrate after application), with a building of adhesion over time to form a sufficiently strong bond. The methods for determining and describing positionability and repositionability are described in detail in the Examples section below.

Also disclosed herein are methods of preparing adhesive laminate articles. These articles include not only the surface modified pressure sensitive adhesive layer articles described above, but also articles that incorporate the surface modified pressure sensitive adhesive layer articles. The methods include providing a pressure sensitive adhesive layer comprising a first major surface and a second major surface, wherein at least one of the major surfaces comprises a plurality of non-pressure sensitive adhesive structures disposed on the major surface of the pressure sensitive adhesive layer, the plurality of non-pressure sensitive adhesive structures being arrayed in a random or non-random pattern, where the non-pressure sensitive adhesive structures are applied to the major surface of the pressure sensitive adhesive layer by direct contact printing, as described above, and contacting the adhesive layer to the surface of an article to form a laminate. The surface of the article may, for example, be the surface of a film, the surface of a rigid or non-rigid substrate, or the outer surface of a device.

In some embodiments, the method also includes applying pressure to the laminate, such that prior to applying pressure to laminate the adhesive layer is positionable and/or repositionable and such that the plurality of non-pressure sensitive adhesive structures become at least partially submerged in the adhesive layer. Typically the plurality of non-pressure sensitive adhesive structures becomes completely submerged in the adhesive layer.

A wide range of laminate articles may be prepared this way, laminate articles in which the surface of an article to which the adhesive layer is laminated comprises the surface of an optical film, the surface of a rigid or nonrigid substrate, or the exterior surface of a device. A wide variety of films and other substrates are suitable.

In some embodiments, the second major surface of the adhesive layer comprises a substrate. In some embodiments, this substrate comprises a tape backing, or a film substrate. In other embodiments, the substrate comprises a release liner. The release liner can be a structured release liner or a flat release liner. In embodiments where the substrate comprises a backing or a film, the exterior surface of the backing or film (the side opposite to the side in contact with the pressure sensitive adhesive layer) may have coatings, printing, or additional layers attached thereto. Examples of suitable coatings include low adhesion coatings, antistratch coatings, antifingerprint coatings, matte coatings, hardcoats, and the like.

Articles where the substrate comprises a flat release liner can be used to prepare embodiments where both major surfaces of the pressure sensitive adhesive layer are surface modified. In these embodiments, the flat release liner can be removed to expose the second major surface of the adhesive layer, material can be applied to the second major surface of the pressure sensitive adhesive layer by direct contact printing to form a plurality of non-pressure sensitive adhesive structures on the second major surface of the pressure sensitive adhesive layer, and a microstructured release liner containing a plurality of depressions can be contacted to the second major surface of the pressure sensitive adhesive layer and the plurality of non-pressure sensitive adhesive structures. Just as described above, with the microstructured release liner containing a plurality of depressions, at least some of the depressions are aligned with non-pressure sensitive adhesive structures.

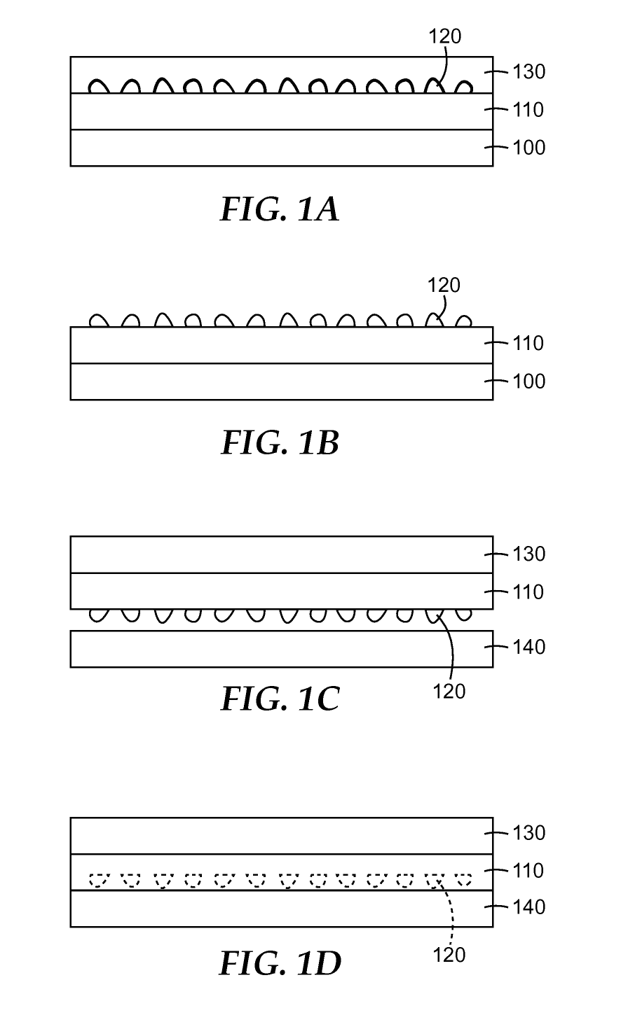

FIGS. 1A-1D illustrate some embodiments of articles and methods of preparing laminate articles of this disclosure. In FIG. 1A, an adhesive article is illustrated comprising substrate layer 100, adhesive layer 110, non-pressure sensitive adhesive structures 120 on the surface of adhesive layer 110, and protective liner 130. Protective liner 130 may be a conformable protective sheet or a microstructured release liner, where at least some of the depressions on microstructured release liner 130 are aligned with non-pressure sensitive adhesive structures 120. The depressions in protective liner 130 shown in FIG. 1A are all aligned with non-pressure sensitive adhesive structures 120, but, as discussed above, this need not be the case.

FIG. 1B illustrates the article of FIG. 1A where protective liner 130 has been removed to expose non-pressure sensitive adhesive structures 120 on the surface of adhesive layer 110. Substrate layer 100 is also present.

FIG. 1C illustrates the article of FIG. 1B contacted to the surface of a substrate 140, such that non-pressure sensitive adhesive structures 120 on the surface of adhesive layer 110 contact substrate 140.

FIG. 1D illustrates the article of FIG. 1C after the passage of time and/or the application of pressure. Adhesive layer 110 is in direct contact with substrate 140 because non-pressure sensitive adhesive structures 120 on the surface of adhesive layer 110 have become submerged into adhesive layer 110.

### Examples

Surface modified adhesive constructions were prepared by using direct contact printing methods. The resultant constructions provide surface modified adhesives which provide localized features such as tack control without compromising the performance of the adhesive. A structured liner was used to protect the structures on the adhesive and thus maintain positionability and repositionability. A conformable liner was also used to protect the structures on the adhesive. The refractive index of the structures were matched to the adhesive to show that the printed adhesive applied to glass had essentially the same optical properties as the unprinted adhesive applied to glass as shown in the following examples.

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company, St. Louis, Mo. unless otherwise noted. The following abbreviations are used herein: BCM=billion cubic micrometers; m/min=meters per minute; mm=millimeters; cm=centimeters.

### Materials:

| Abbreviation | Description |
|---|---|
| L1 | Liner, 50 micrometers thick, commercially available from DuPont |
| | Teijin Films, Chester, VA as “MELINEX 618” |
| L2 | Structured Liner, 50 micrometers thick, commercially available from |
| | DuPont Teijin Films, Chester, VA as “MELINEX 618”. Embossed |
| | with a hexagonal pattern with a pitch of 1 mm with 200 micrometer |
| | walls and 800 micrometer diameter wells. The wells were 20 |
| | micrometers deep. |
| CL | Conformable Liner, commercially available from 3M Company, St. |
| | Paul, MN as “SCPM-3” premasking film |
| ADH1 | Adhesive, Silicone polyoxamide as described in Example 25 (with |
| | elastomer/MQ ratio of 90/10) of U.S. Pat. No. 7,981,995 (Hays) 51 |
| | micrometers thick on primed PET (HOSTAPHAN 3SAB primed |
| | polyester film available from Mitsubishi Polyester Film Inc, Greer, |
| | S.C.) |
| ADH2 | Adhesive, Acrylic, 25 micrometers thick, commercially available from |
| | 3M Company, St. Paul, MN as “8171” |
| AM1 | Acrylate Monomer, Aliphatic Urethane Hexaacrylate, commercially |
| | available from Allnex, Smyrna, GA as “EBECRYL 8301-R”. |
| AM2 | Acrylate Monomer, Hexanediol Diacrylate, commercially available |
| | from Ciba/BASF, Hawthorne, NY as “LAROMER” HDDA. |
| AM3 | Acrylate Monomer, Pentaerythritol Tetracrylate, commercially |
| | available from Sigma-Aldrich, St. Louis, MO as “PETA 408263”. |
| PI1 | Photoinitiator, 70:30 blend of oligo [2-hydroxy-2-methyl-1-[4-(1- |
| | methylvinyl) phenyl] propanone] and 2-Hydroxy-2-methyl-1-phenyl- |
| | 1-propanone, commercially available from Esstech, Inc., Essington, |
| | PA as “PL100” |
| CO1 | Copolymer, polyether siloxane, commercially available from Evonik |
| | Industries, Essen, Germany, as “TEGO Glide 432” |
| S1 | Silicone, commercially available from Evonik Industries, Essen, |
| | Germany, as “TEGO RC 702” |

### Test Methods

### Slideability Test Method

The glass surface of a 4^{th} generation IPAD (Apple Inc. Cupertino, Calif.), was wiped with a dry PN-99 polyester knit cloth (Contec Inc. Spartaburg, S.C.). A 5 cm by 8 cm strip of printed or non printed adhesive was placed onto the glass surface. The adhesive sample was then dragged across the surface. A slideability rating was given based on the definitions below and reported in the Table 1 below. After the rating was assessed, finger pressure was used to wet the adhesive onto the glass surface if not wetted already. All testing was performed at room temperature.

Slideability Ratings

| Rating: | Description: |
|---|---|
| Slight | essentially no slide |
| Limited | difficult to slide |
| OK | easily slides |
| Excellent | very easy to slide |

### Refractive Index

Refractive Index was measured using a Metricon 2010/M Prism Coupler (available from Metricon Corporation, Pennington, N.J.).

### Luminous Transmission, Clarity, and Haze

Luminous transmission, clarity, and haze were measured according to ASTM D1003-00 using a Gardner Haze-Guard Plus model 4725 (available from BYK-Gardner Columbia, Md.). Adhesive samples were laminated onto a single glass slide and measured.

### Surface Profile

Liners were removed after 3 days. Surface profile measurements were made on a Keyence VK-9500 confocal microscope available from Keyence, Itasca, Ill. The magnification was set to 50×. Images were captured, analyzed and plots generated. Surface profile plots were generated using VK-Analyzer Software version 2.2.5.0 available from Keyence, Itasca, Ill. 3D profile plots were generated using VISION analysis software version 3.44 available from Vecco Instruments Inc., Plainview, N.Y.

### Printed Examples for Slideability

### Acrylate Formulation:

The printed structure is an acrylate formulation composed of 50 wt % AM1, 25 wt % AM2, and 25 wt % AM3 with 1 wt % PI1.

### Printing Structures:

Example 1 (E1) was prepared by printing the acrylate formulation described above on ADH1 using a FLEXI-PROOFER Flexographic printing unit (Weller Patents Development, Putney, London England). The anilox roll used was 4 BCM 700 lines/inch (1,778 lines/cm), hexagonal cells engraved at 60 degrees. After printing the samples were cured in a LIGHTHAMMER 6 UV curing system with a D bulb (Heraeus Noblelight Fusion UV Inc., Gaitherburg, Md.). Curing took place at 100% power and 25 ft/min (7.6 m/min), 1 pass. This resulted in 40 micrometer structures with 50 micrometer gaps on the adhesive. Example 2 (E2) was prepared the same as E1, but a structured liner (L2) was applied to the structured side.

Control Examples, (C1) ADH1 without printed structure with a structured liner (L2) and (C2) ADH1 with printed structure, but with a flat (nonstructured) liner (L1), were prepared using the same procedures as the Examples.

Slideability testing was performed for Examples using the Slideability Test Method above. The slideability data are shown in Table 1 below.

TABLE 1
Slideablility Results

| | | Printed | | |
|---|---|---|---|---|
| Sample | Adhesive | structure | Liner | Slideability |
| C1 | ADH1 | None | L2 | Slight |
| C2 | ADH1 | Printed | L1 | Slight |
| E1 | AHD1 | Printed* | None | Excellent |
| E2 | ADH1 | Printed | L2 | Excellent |

*The printed surface was not brought into contact with another surface or film until testing.

Surface profiles were generated using the Surface Profile Test Method above.

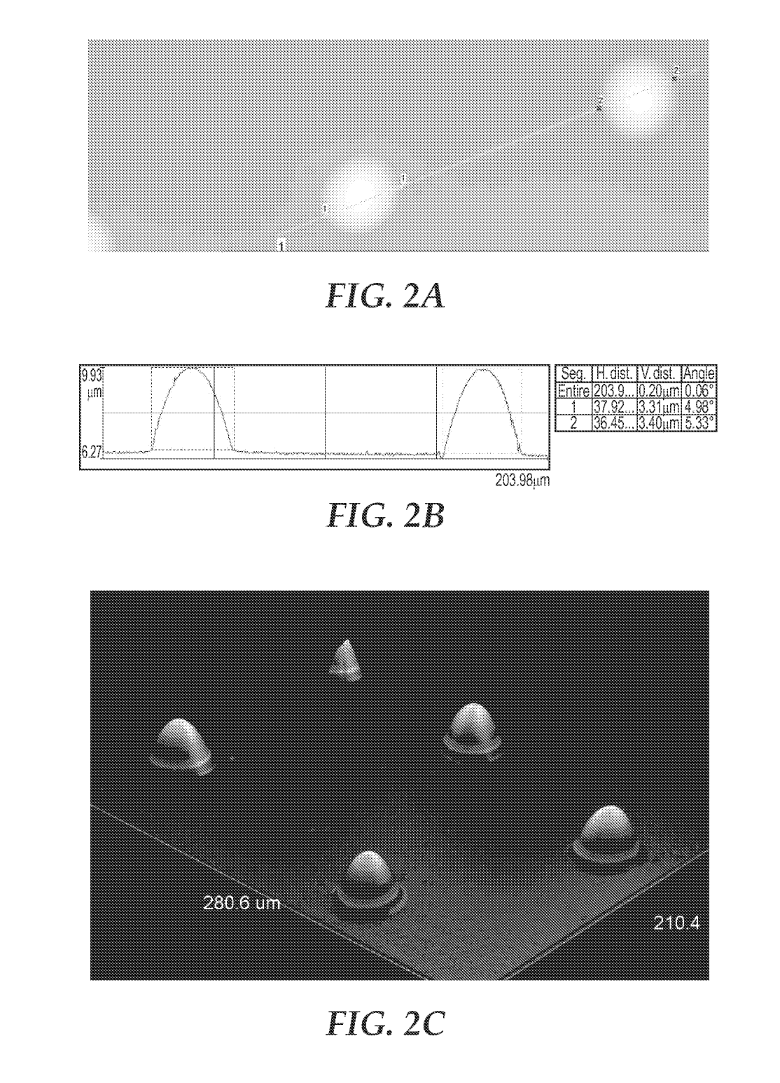

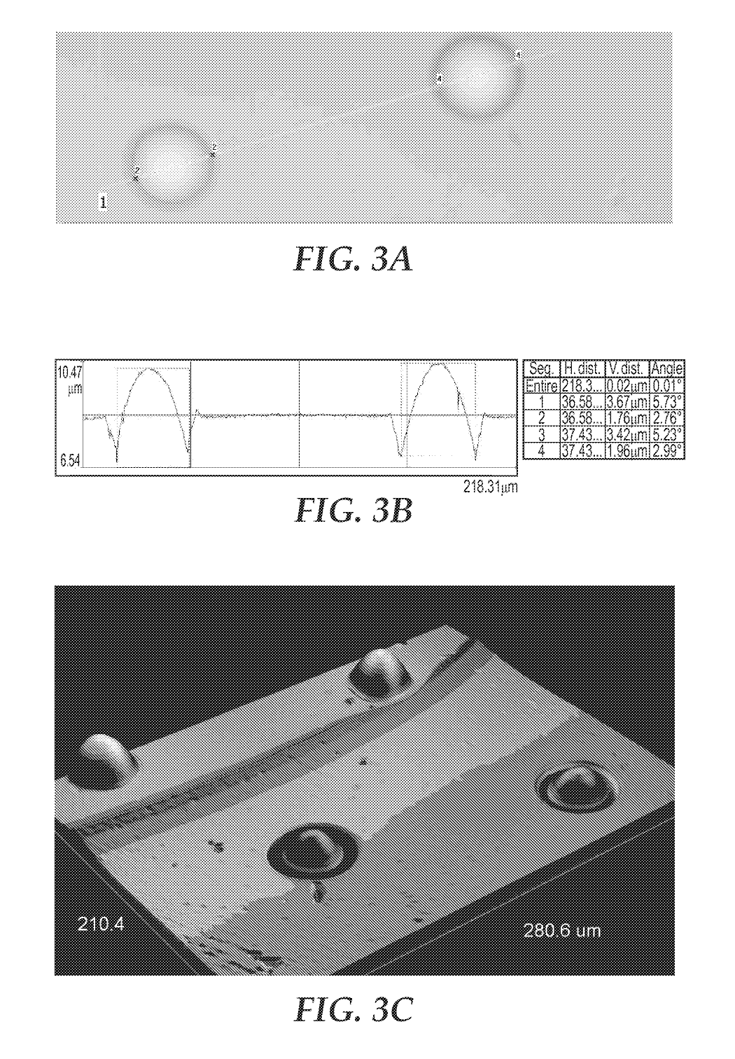

FIG. 2A shows the plan view and FIG. 2B the profile view of example E2 from an area of the sample that was protected (liner not in contact with the printed structures) by the structured liner L2. FIG. 2C is the 3D plot of the same area of example E2 in FIG. 2B. FIG. 3A shows the plan view and FIG. 3B shows the profile view of the printed structures from example E2 in an area of the sample that was in contact with the embossed section of liner L2. FIG. 3C is the 3D plot of the same area example E2 in FIG. 3B.

### Conformable Liner Example

The acrylate formulation from the previous example was printed onto adhesive ADH2 with the top liner removed, using a FLEXI-PROOFER Flexographic printing unit (Weller Patents Development, Putney, London England). The anilox roll used was 4 BCM 700 lines/inch (1,778 lines/cm), hexagonal cells engraved at 60 degrees. After printing the sample was cured in a LIGHTHAMMER 6 UV curing system with a D bulb (Heraeus Noblelight Fusion UV Inc., Gaitherburg, Md.). Curing took place at 100% power and 25 ft/min (7.6 m/min), 1 pass. This resulted in 40 micrometer structures with 50 micrometer gaps on the adhesive. A conformable liner CL was applied with a hand roller over the printed structures. A weight of 2.87 kg was added over a 3.18 cm diameter area (34.9 kPa) of the laminated structure. The weight was left on the sample for 16 hours. The weight was removed, then the conformable liner was removed and the printed structures were examined under a confocal microscope (VK-9510, Keyence, Itasca, Ill.). The microscope image showed no sinking of the printed features into the adhesive.

### Index Matched Structures and Adhesive Example

The refractive index of ADH1 was measured using the Refractive Index Test Method above. Results are listed in Table 2. To formulate a matching refractive index material for flexographic printing, 1 wt % of CO1 was added to 99 wt % S1. The refractive index matched formulation was coated with a Mayer bar onto PET and then cured in a LIGHTHAMMER 6 UV curing system with a D bulb (Heraeus Noblelight Fusion UV Inc., Gaitherburg, Md.). Curing took place at 100% power and 25 ft/min (7.6 m/min), 1 pass. The thickness of the coating was 5 micrometers. The refractive index of the cured refractive index coating was measured using the Refractive Index Test Method above. Results are listed in Table 2.

TABLE 2
Refractive Index Measurements

| Sample | Refractive Index |
|---|---|
| ADH1 | 1.4074 |
| Refractive index matched coating | 1.4214 |

The index matched formulation was printed on ADH1 using the FLEXI-PROOFER Flexographic printing unit (Weller Patents Development, Putney, London England). The anilox roll used was 4 BCM 700 lines/inch (1,778 lines/cm), hexagonal cells engraved at 60 degrees. After printing the sample was cured in a LIGHTHAMMER 6 UV curing system with a D bulb (Heraeus Noblelight Fusion UV Inc., Gaitherburg, Md.). Curing took place at 100% power and 25 ft/min (7.6 m/min), 1 pass. This resulted in 39 micrometer structures, 2.8 micrometer high, with 96 micrometer pitch on the adhesive.

5 cm×8 cm glass microscope slides were prepared by spraying with IPA and then wiping with a PN-99 polyester knit cloth (Contec Inc. Spartaburg, S.C.). Both sides of the glass were cleaned and allowed to dry. Example 3 (E3) was prepared by applying index matched printed ADH1 to a clean glass slide with a hand roller. Haze, Transmission, and Clarity were measured using the Luminous Transmission, Clarity, and Haze Test Method above. Results are shown in Table 3. Comparative Example 3 (C3), was prepared by applying ADH1 to a clean glass slide with a hand roller. Haze, Transmission, and Clarity were measured using the Luminous Transmission, Clarity, and Haze Test Method above. Results are shown in Table 3.

TABLE 3
Luminous Transmission, Clarity, and Haze for structured and non
structured constructions

| Sample | % Haze | % Transmission | % Clarity |
|---|---|---|---|
| C3 | 1.72 | 91.7 | 99.8 |
| E3 | 1.81 | 91.5 | 99.5 |

What is claimed is:

1. An adhesive article comprising:
a substrate comprising a first major surface and a second major surface;
a layer of pressure sensitive adhesive comprising a first major surface and a second major surface, wherein the second major surface of the pressure sensitive adhesive layer is disposed on the first major surface of the substrate; and
a plurality of non-pressure sensitive adhesive structures disposed on the first major surface of the pressure sensitive adhesive layer, the plurality of non-pressure sensitive adhesive structures being arrayed in a random or non-random pattern, wherein the non-pressure sensitive adhesive structures are applied to the first major surface of the pressure sensitive adhesive layer by direct contact printing, and wherein the non-pressure sensitive adhesive structures are not embedded in the pressure sensitive adhesive layer.

2. The adhesive article of claim 1, further comprising:
a microstructured release liner in contact with the first major surface of the pressure sensitive adhesive layer and the plurality of non-pressure sensitive adhesive structures,
the microstructured release liner containing a plurality of depressions, wherein at least some of the depressions are aligned with non-pressure sensitive adhesive structures.

3. The adhesive article of claim 1, further comprising:
a protective sheet in contact with the first major surface of the pressure sensitive adhesive layer and the plurality of non-pressure sensitive adhesive structures,
the protective sheet comprising a conformable sheet or a conformable coating.

4. The adhesive article of claim 1, wherein direct contact printing comprises flexographic printing, patterned roll coating, letterpress printing, lithography, or stencil printing.

5. The adhesive article of claim 1, wherein applying the non-pressure sensitive adhesive structures to the first major surface of the pressure sensitive adhesive layer by direct contact printing comprises applying a material to the first major surface of the pressure sensitive adhesive layer, wherein the material comprises a 100% solids composition, a mixture of liquid and solid, a curable composition, or an ink.

6. The adhesive article of claim 5, wherein the material comprises an elastomeric material, a thermoplastic material, or a curable material.

7. The adhesive article of claim 6, wherein the material comprises a heat activated adhesive.

8. The adhesive article of claim 5, wherein applying a material to the first major surface of the pressure sensitive adhesive layer further comprises drying the material, curing the material, or a combination thereof.

9. The adhesive article of claim 5, wherein the material comprises an ink, a paste or 100% solids material comprising a conductive metal, and wherein the plurality of non-pressure sensitive adhesive structures comprises a circuit.

10. The adhesive article of claim 1, wherein the pressure sensitive adhesive layer has a thickness and the non-pressure sensitive adhesive structures have a thickness, such that the thickness of the non-pressure sensitive adhesive is less than 50% of the thickness of the pressure sensitive adhesive layer.

11. The adhesive article of claim 1, wherein the substrate comprises a microstructured release liner, and the second major surface of the pressure sensitive adhesive layer comprise a plurality of non-pressure sensitive adhesive structures disposed on the second major surface of the pressure sensitive adhesive layer, the plurality of non-pressure sensitive adhesive structures being arrayed in a random or non-random pattern, wherein the non-pressure sensitive adhesive structures are applied to the first major surface of the pressure sensitive adhesive layer by direct contact printing.

12. The adhesive article of claim 1, wherein the adhesive article is optically clear.

13. The adhesive article of claim 1, wherein the adhesive article is positionable and/or repositionable.

14. A method of making an adhesive laminate article comprising:
providing a pressure sensitive adhesive layer comprising a first major surface and a second major surface, wherein at least one of the major surfaces comprises a plurality of non-pressure sensitive adhesive structures disposed on the major surface of the pressure sensitive adhesive layer, the plurality of non-pressure sensitive adhesive structures being arrayed in a random or non-random pattern, wherein the non-pressure sensitive adhesive structures are applied to the major surface of the pressure sensitive adhesive layer by direct contact printing, and wherein the non-pressure sensitive adhesive structures are not embedded in the pressure sensitive adhesive layer; and
contacting the adhesive layer to the surface of an article to form a laminate.

15. The method of claim 14, further comprising:
applying pressure to the laminate, such that prior to applying pressure to laminate the adhesive layer is positionable and/or repositionable, and such that the plurality of non-pressure sensitive adhesive structures become at least partially submerged in the adhesive layer.

16. The method of claim 14, wherein providing an adhesive layer comprises:
providing a substrate, the substrate having a first major surface and a second major surface;
applying an adhesive or pre-adhesive composition to the first major surface of the substrate to form a pressure sensitive adhesive layer with a first major surface and a second major surface, wherein the second major surface of the pressure sensitive adhesive layer is adjacent to the first major surface of the substrate; and
direct contact printing a material onto the first major surface of the pressure sensitive adhesive layer.

17. The method of claim 16, further comprising contacting a microstructured release liner to the first major surface of the pressure sensitive adhesive layer and the plurality of non-pressure sensitive adhesive structures, the microstructured release liner containing a plurality of depressions, wherein at least some of the depressions are aligned with non-pressure sensitive adhesive structures.

18. The method of claim 16, wherein direct contact printing comprises flexographic printing, patterned roll coating, letterpress printing, lithography, or stencil printing.

19. The method of claim 16, wherein applying the non-pressure sensitive adhesive structures to the first major surface of the pressure sensitive adhesive layer by direct contact printing comprises applying a material to the first major surface of the pressure sensitive adhesive layer, wherein the material comprises a 100% solids composition, a mixture of liquid and solid, a curable composition, or an ink.

20. The method of claim 19, wherein the material comprises an elastomeric material, a thermoplastic material, or a curable material.

21. The method of claim 20, wherein the material comprises a heat activated adhesive.

22. The method of claim 19, wherein applying a material to the first major surface of the pressure sensitive adhesive layer further comprises drying the material, curing the material, or a combination thereof.

23. The method of claim 16, wherein the material comprises an ink, paste or 100% solids composition comprising a conductive metal, and wherein the plurality of non-pressure sensitive adhesive structures comprises a circuit.

24. The method of claim 14, wherein the pressure sensitive adhesive layer has a thickness and the non-pressure sensitive adhesive structures have a thickness, such that the thickness of the non-pressure sensitive adhesive is less than 50% of the thickness of the pressure sensitive adhesive layer.

25. The method of claim 16, wherein the substrate comprises a release liner;
the release liner is removed to expose the second major surface of the adhesive layer;
applying a material to the second major surface of the pressure sensitive adhesive layer by direct contact printing to form a plurality of non-pressure sensitive adhesive structures on the second major surface of the pressure sensitive adhesive layer;
providing a microstructured release liner, and
contacting the microstructured release liner to the second major surface of the pressure sensitive adhesive layer and the plurality of non-pressure sensitive adhesive structures,
the microstructured release liner containing a plurality of depressions, wherein at least some of the depressions are aligned with non-pressure sensitive adhesive structures.

26. The method of claim 25, wherein applying a material to the second major surface of the pressure sensitive adhesive layer further comprises drying the material, curing the material, or a combination thereof.

27. The method of claim 14, wherein the surface of an article comprises the surface of an optical film, the surface of a rigid or nonrigid substrate, or the exterior surface of a device.
